(19) United States
(12) Patent Application Publication
(10) Pub. No.: US 2015/0020136 A1
(43) Pub. Date: Jan. 15, 2015

(54) MULTIMEDIA STREAM TRANSMISSION METHOD AND SYSTEM BASED ON TERAHERTZ WIRELESS COMMUNICATION

(71) Applicant: HUIZHOU TCL MOBILE COMMUNICATION CO., LTD, HUIZHOU (CN)

(72) Inventors: Kailong Wang, Huizhou (CN); Xianglai Li, Huizhou (CN); Qi Ge, Huizhou (CN)

(73) Assignee: HUIZHOU TCL MOBILE COMMUNICATION CO., LTD, HUIZHOU (CN)

(21) Appl. No.: 14/370,386

(22) PCT Filed: Feb. 28, 2013
(86) PCT No.: PCT/CN2013/071995

§ 371 Date: Jul. 2, 2014

(30) Foreign Application Priority Data
Apr. 24, 2012 (CN) 201210121661.0

(51) Int. Cl. H04N 21/2383

(52) U.S. Cl. CPC H04N 21/2383
USPC 725/116

(57) ABSTRACT

Multimedia stream transmission methods and a systems, based on terahertz wireless communication, are provided. A media providing device may send a multimedia stream using a terahertz wireless signal. A media receiving device may receive a multimedia stream in real time, so as to achieve real-time broadcast and transmission of the multimedia stream. Through a transmission mode based on terahertz wireless communication, an associated transmission rate and quality of an associated multimedia stream are improved. Thus, quality of a picture displayed by an associated multimedia stream may be enhanced.

### TECHNICAL FIELD

The present disclosure relates to the field of information technology, and in particular to multimedia stream transmission methods and systems based on terahertz wireless communication.

### BACKGROUND

Multimedia devices are often used to transmit shared video output to an external screen. For example, a screen may be shared between a mobile terminal, a television and a projector. More particularly, a laptop computer/smartphone is traditionally connected to a projector/display device through a VGA/HDMI/AV cable in order to transmit a video signal.

However, traditional shared multimedia transmission devices exclude some high-end HDMI interfaces, picture quality transmission ability of VGA and AV are limited, video interfaces are not beneficial for optimizing a product appearance structure, and associated cables are inconvenient. While wireless multimedia stream shared transmission is generally available, wireless frequency bands are limited to GHz bands. Wireless transmission ability in the GHz wireless frequency band is limited, which may sacrifice quality of associated multimedia stream transmission and cause time delay.

### SUMMARY

In view of the foregoing deficiencies multimedia stream transmission methods and systems, based on terahertz wireless communication, are provided.

A multimedia stream transmission method, based on terahertz wireless communication, may include processing, by a media providing device, a multimedia stream into a data packet suitable for terahertz wireless signal transmission, and sending the data packet from a first terahertz communication interface drive to a first terahertz transceiver, wherein the first terahertz transceiver externally broadcasts the data packet through a terahertz wireless signal. The method may also include receiving, by a media receiving device, the terahertz wireless signal using a second terahertz transceiver, and acquiring the data packet, wherein after the first terahertz transceiver sends the data packet to the second terahertz transceiver, the media receiving device processes the data packet into a playable multimedia stream.

In another embodiment, a multimedia stream transmission method, based on terahertz wireless communication, may include processing, by a media providing device, a multimedia stream into a data packet suitable for terahertz wireless signal transmission, and externally broadcasting the data packet through a terahertz wireless signal. The method may further include receiving, by a media receiving device, the data packet through the terahertz wireless signal and processing the data packet into a playable multimedia stream.

In a further embodiment, a multimedia stream transmission system, based on terahertz wireless communications, may include a media providing device, for processing a multimedia stream into a data packet suitable for terahertz wireless signal transmission and externally broadcasting the data packet through a terahertz wireless signal. The system may also include a media receiving device, used for receiving the data packet through the terahertz wireless signal and processing the data packet into a playable multimedia stream.

Multimedia stream transmission methods and systems, based on terahertz wireless communication, may include a media providing device that may send a multimedia stream using a terahertz wireless signal and a media receiving device may receive the multimedia stream in real time to provide real-time broadcast and transmission of the multimedia stream. Through a transmission mode, based on terahertz wireless communication, a transmission rate and quality of a multimedia stream, and a picture image of the multimedia stream may be improved when compared to traditional wired transmission and GHz frequency band wireless transmission.

### BRIEF DESCRIPTION OF DRAWINGS

FIG. 1 depicts a flow chart of an example multimedia stream transmission method based on terahertz wireless communication;

FIG. 2 depicts a flow chart of an example media providing device for externally broadcasting a multimedia stream in the multimedia stream transmission method of FIG. 1;

FIG. 3 depicts a flow chart of an example media receiving device for receiving a multimedia stream in the multimedia stream transmission method of FIG. 1;

FIG. 4 depicts a flow chart of an example handshake stage in the multimedia stream transmission method of FIG. 1; and

FIG. 5 depicts a structure diagram of an example multimedia stream transmission system based on terahertz wireless communication.

### DETAILED DESCRIPTION

Multimedia stream transmission methods and systems, based on terahertz wireless communication, are provided. To clarify associated objectives, technical solutions and advantages, various embodiments of the claimed invention are described in details with reference to the associated drawings. It should be understood that the specific embodiments described herein are for illustrative purposes and are not intended to limit the scope of the claimed invention in any way.

A multimedia stream transmission method, based on terahertz wireless communication, may include a media providing device that may provide a multimedia stream, may process the multimedia stream to translate the multimedia stream into a data packet suitable for terahertz wireless link transmission, and then may send the data packet out to other terahertz-based devices. A multimedia receiving device may receive a data packet through a terahertz wireless communications signal and may process the data packet into a playable multimedia stream such that, for example, the multimedia stream may be played on various display devices.

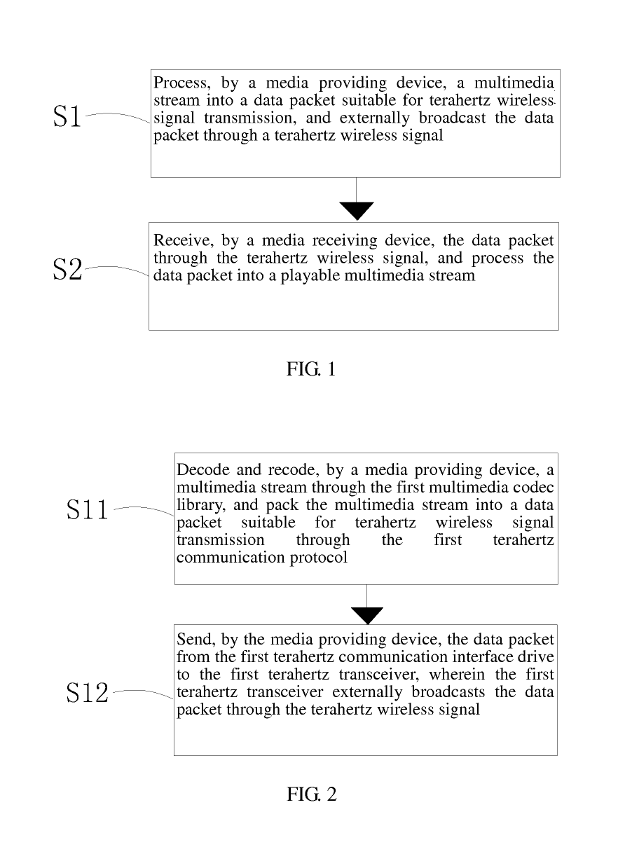

Turning to FIG. 1, a multimedia stream transmission method, based on terahertz wireless communication, is depicted. The method may include processing, by a media providing device, a multimedia stream into a data packet suitable for terahertz wireless signal transmission and externally broadcasting the data packet through a terahertz wireless signal.

A media providing device may be a smartphone, a laptop computer, a PDA or other terminal device that may provide a multimedia stream. A multimedia stream to be transmitted by shared transmission may be stored in a media providing device. A multimedia stream may be an audio or video file. A file format of a multimedia stream may be such common file formats as wmv, rm, rmvb, mpg, 3gp, mp4 or avi. Prior to a multimedia stream being transmitted to a media receiving device using a terahertz wireless signal, the media providing device may process the multimedia stream into a data packet suitable for terahertz wireless signal transmission. Subsequently, the multimedia stream may be transmitted using a terahertz wireless signal.

A multimedia stream transmission method, based on terahertz wireless communications, may include receiving, by a media receiving device, a data packet through a terahertz wireless signal, and processing the data packet into a playable multimedia stream. A media receiving device may be a terminal device with a big screen display device to achieve a better viewing effect. For example, a media receiving device may be a projector, a display device, a television or other terminal device that can play a multimedia stream. A media providing device may receive a data packet sent by a media providing device through a terahertz wireless signal. Subsequent to receiving a data packet, a media providing device may process the data packet and may translate the data packet into a playable multimedia stream for a media receiving device. Furthermore, a multimedia stream may be played on a display device in real time. Because terahertz wireless communications may include large transmission capacity, rapid transmission rate and better directionality, a multimedia stream shared transmission method, based on terahertz wireless communication, may implement smooth transmission of high definition lossless images, and may facilitate sharing screens between multimedia devices. Furthermore, a multimedia stream may be played in real-time via wireless terahertz communication.

A data packet, suitable for terahertz wireless signal transmission, may be processed by a media providing device and/or a media receiving device according to a specific processing procedure as described elsewhere herein.

With reference to FIG. 2, an example flow diagram is depicted for a media providing device to externally broadcast a multimedia stream. A media providing device may externally broadcast a multimedia stream by decoding a multimedia stream using a first multimedia codec library and packing the multimedia stream into a data packet suitable for terahertz wireless signal transmission using a first terahertz communication protocol.

A media providing device may decode and recode a multimedia stream which, for example, may be completed using a first multimedia codec library in the media providing device. A multimedia stream may be processed into audio and video packed data, for example, using standard video coding and audio coding, respectively, algorithms (e.g., a container technology). Subsequently, an information header, that represents a coding format, may be added, thereby, forming a container packet. A container packet may be decoded by parsing an information header of the container packet, acquiring audio and video packed data, and unpacking packed data into a multimedia stream. A media providing device may pack decoded and recoded data into a data packet suitable for terahertz wireless signal transmission using a first terahertz communication protocol stack. A data packet may be sent to a first terahertz communication interface drive. A media providing device may externally broadcast a multimedia stream by sending a data packet from a first terahertz communication interface drive to a first terahertz transceiver. A first terahertz transceiver may externally broadcast a data packet using a terahertz wireless signal.

A first terahertz communication interface drive may send a data packet to a first terahertz transceiver. After receiving a data packet, a first terahertz transceiver may send the data packet to a media receiving device using a terahertz wireless signal. A media receiving device may receive a data packet.

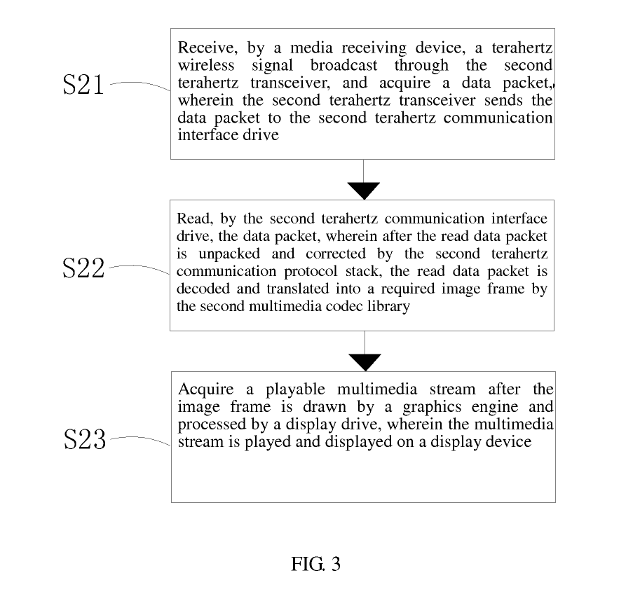

Turning to FIG. 3, an example flow diagram is depicted for a media receiving device to receive a multimedia stream. A media receiving device may receive a terahertz wireless signal, broadcast by a first terahertz transceiver, using a second terahertz transceiver and may acquire a data packet. A second terahertz transceiver may send a data packet to a second terahertz communication interface drive.

A second terahertz transceiver and a second terahertz communication interface drive may be arranged in a media receiving device. Structures and operating principles of a second terahertz transceiver and a first terahertz transceiver may be similar. Structures and operating principles of a second terahertz communication interface drive and a first terahertz communication interface drive may also be similar. A first terahertz communication interface drive may have an opposite processing procedure of a data packet and a multimedia stream when compared to a second terahertz communication interface drive. Subsequent to receiving a terahertz wireless signal, broadcast by a first terahertz transceiver, and acquiring an associated data packet, a second terahertz transceiver may send the data packet to a second terahertz communication interface drive. A second terahertz communication interface drive may perform, following processing on a data packet, reading the data packet. Subsequent to being read, a data packet may be unpacked and corrected by a second terahertz communication protocol stack. A data packet may be decoded and translated into an image frame by a second multimedia codec library.

A second terahertz communication interface drive, in a media receiving device, may read a data packet. A data packet, read by a second terahertz communication interface drive, may be unpacked and corrected using a terahertz communication protocol stack. Unpacked and corrected data may be decoded using a second multimedia decoding library, arranged in a media receiving device, and may be translated into a data frame. An image frame may be translated when the image frame is being drawn by a graphics engine and/or processed by a display drive into a playable multimedia stream. A multimedia stream may be played and displayed on a display device.

A graphics engine and a display drive also be arranged in a media receiving device. A graphics engine and a display drive may process an image frame such that the image frame may be normally displayed and played on a display device. An image frame, acquired after a second multimedia decoding library decodes and translates the data, may enable a multimedia stream to be stably played on a display device. A display device may be included on a media receiving device and an image frame may be translated using such drawing work as retouching and beautification using, for example, a graphics engine, as well as, displaying related processing performed by the display drive.

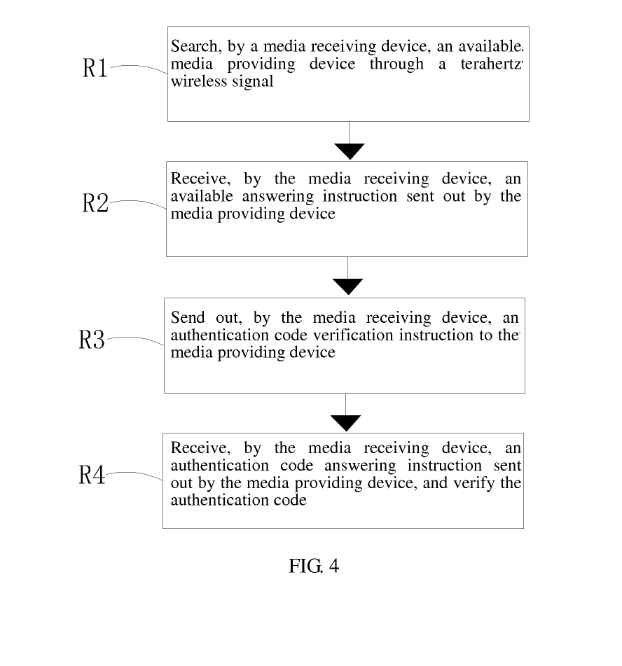

A handshake stage may be included before a media providing device transmits multimedia stream data to a media receiving device in order to perform search and validation prior to transmission. With reference to FIG. 4, an example flow diagram of a handshake stage is depicted. A handshake stage may include searching, by a media receiving device, an available media providing device through a terahertz wireless link. A handshake stage may include receiving, by a media receiving device, an available answering instruction sent out by a media providing device. A handshake stage may include sending out, by a media receiving device, an authentication code verification instruction to a media providing device. A handshake stage may include receiving, by a media receiving device, an authentication code answering instruction sent out by a media providing device. A data transmission may be performed after successful authentication and verification of a media receiving device and a media providing device.

A handshake stage may include functions related to protecting a data transmission and/or recognizing a transmission device. A media receiving device may recognize an available media providing device in advance and may perform an authentication code verification step after receiving an available answering sent out by a media providing device. A multimedia stream transmission procedure may be entered after a verification procedure of a handshake stage is completed and an authentication code used for protecting a data transmission is established.

A data transmission stage may be entered after a handshake stage is completed. A data transmission stage may include a media providing device sending information of a multimedia stream to a media receiving device using a terahertz wireless signal. After receiving a multimedia stream playable, sent out by a media providing device, a media receiving device may perform transmission. A media providing device may send multimedia stream data to a media receiving device using a terahertz wireless signal.

When a media receiving device does not need to play a received multimedia stream, the media receiving device may initiatively send out an instruction to stop receiving associated multimedia stream data. After receiving an instruction to stop sending multimedia stream data, a media providing device may answer the instruction and stop sending the multimedia stream data and an associated data transmission is ended.

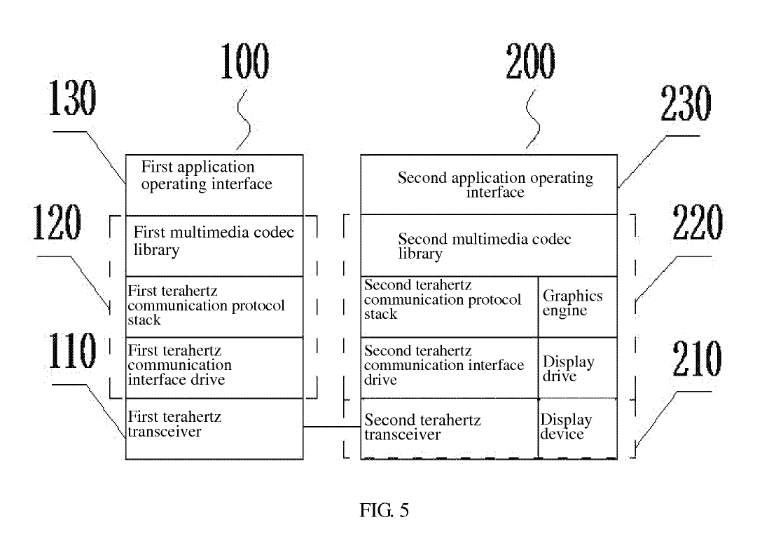

With reference to FIG. 5, a multimedia stream transmission system, based on terahertz wireless communications, may include a media providing device 100 for processing a multimedia stream into a data packet suitable for terahertz wireless signal transmission and for externally broadcasting the data packet using a terahertz wireless signal. A multimedia stream transmission system, based on terahertz wireless communications, may include a media receiving device 200 for receiving a data packet using a terahertz wireless signal and for processing the data packet into a playable multimedia stream.

A media receiving device 100 may include three function units: a first function unit 130, a second function unit 120 and a third function unit 110. A first function unit 130 may be a first application operating interface for user interactive operation. A second function unit 120 may include a first terahertz communication interface drive, a first terahertz communication protocol stack and a first multimedia codec library. A first terahertz communication interface drive may be used for reading a data packet, a first terahertz communication protocol stack for packing a multimedia stream into a data packet, and a first multimedia codec library for decoding and recoding the multimedia stream. A third function unit 110 may include a first terahertz transceiver for receiving a data packet suitable for terahertz wireless signal transmission.

A working flow of a media providing device 100 may begin when a user selects and transmits a multimedia stream to be transmitted for sharing via a first application operating interface. A multimedia stream, after being decoded and recoded by a first multimedia codec library, may be sent to a first terahertz protocol stack. A first terahertz protocol stack may pack a multimedia stream into a data packet suitable for terahertz wireless signal transmission. A data packet may be sent to a first terahertz transceiver by a first terahertz communication interface drive and broadcast externally by a first terahertz transceiver using a terahertz wireless signal.

A media receiving device 200 may include three function units: a fourth function unit 230, a fifth function unit 220 and a sixth function unit 210. A fourth function unit 230 may be a second application operating interface for user interactive operation. A fifth function unit 220 may include a second terahertz communication interface drive, a second terahertz communication protocol stack, a second multimedia codec library, a graphics engine and a display drive. A second terahertz communication interface drive may be used for reading a data packet, a second terahertz communication protocol stack for unpacking and correcting the data packet, a second multimedia codec library for decoding and translating the data packet into a required image frame, and a graphics engine and a display drive respectively used for drawing an image frame and processing the image frame into a playable multimedia stream. A sixth function unit 210 may include a second terahertz transceiver and a display device. A second terahertz transceiver may be used for receiving and sending a data packet suitable for terahertz wireless signal transmission. A display device may be used for playing and displaying a multimedia stream.

A working flow for a media receiving device may include a second terahertz transceiver that receives a data packet and the data packet may be read using a second terahertz communication interface drive. A read data packet, after being unpacked and corrected by a second terahertz protocol stack, may be sent to a second multimedia codec library to be decoded and translated into a required image frame. After being drawn by a graphics engine and processed by a display drive, an image frame may play an associated multimedia stream on a display device. A user may adjust a playing procedure of a multimedia stream on a user operating interface, for example, by adjusting a playing picture quality of the multimedia stream, or pausing or breaking a playing procedure of the multimedia stream.

A media providing device may be a smartphone, a laptop computer or a PDA. A media receiving device may be a projector, a display device or a television. A user play a video or audio file on a big screen of a media receiving device in real time by sending a multimedia stream file on a media providing device to a media receiving device using a terahertz wireless signal, thus greatly improving a user experience.

A number of media providing devices may be one, while a number of a media receiving devices may be greater than one. In this way, an associated multimedia system may evolve into a broadcasting stream multimedia system. A multimedia stream transmission mode may enable a user to receive a data packet and watch or listen to a video or audio file at the same time without waiting for an entire multimedia stream file to be transmitted to a media receiving device.

A multimedia stream transmission method and system, based on terahertz wireless communication, may include a media providing device that sends a multimedia stream using a terahertz wireless signal and a media receiving device that receives the multimedia stream in real time to achieve real-time broadcast and transmission of the multimedia stream. A multimedia stream transmission rate may reach 10 Gps and only 30% band width may be occupied for 1080/24 bit, true color, non-packing transmission. A high band width and full digitization multimedia stream transmission mode are far better than wired transmission mode and Ghz frequency band wireless transmission mode with regard to picture quality. Moreover, wireless terahertz communications does not need wired connections and does not need to traverse a shell of a related device, thus, saving certain mainboard space and avoiding use of a physical connector. In addition, wireless terahertz communications avoids use of cables, such that a wireless terahertz communications system may be more convenient to use. Furthermore, a broadcasting type stream media transmission mode may be provided and one media providing device can share a multimedia stream image with multiple media receiving devices without hardware improvement, which cannot be implemented by wireless terahertz communications traditional transmission mode.

It should be understood that applications of the methods and systems of the present disclosure are not limited to the foregoing examples. A person having ordinary skill in the art may improve or transform the methods and systems according to the foregoing descriptions. All improvements and transformations shall fall within the protection scope of the accompanying claims.

1. A multimedia stream transmission method based on terahertz wireless communication, comprising the following steps:
processing, by a media providing device, a multimedia stream into a data packet suitable for terahertz wireless signal transmission and sending the data packet from a first terahertz communication interface drive to a first terahertz transceiver, wherein the first terahertz transceiver externally broadcasts the data packet through a terahertz wireless signal; and
receiving, by a media receiving device, the terahertz wireless signal a second terahertz transceiver and acquiring the data packet, wherein after the second terahertz transceiver sends the data packet to a second terahertz communication interface drive, the media receiving device processes the data packet into a playable multimedia stream.

2. The multimedia stream transmission method based on terahertz wireless communication according to claim 1, further comprising the step:
decoding, by the media providing device, the multimedia stream through a first multimedia codec library and packing the multimedia stream into a data packet suitable for terahertz wireless signal transmission using a first terahertz communication protocol after recoding.

3. The multimedia stream transmission method based on terahertz wireless communication according to claim 1, further comprising the steps:
reading, by the second terahertz communication interface drive, the data packet, wherein after a read data packet is unpacked and corrected by a second terahertz communication protocol stack, the read data packet is decoded and translated into a required image frame by a second multimedia codec library; and
translating the image frame, after being drawn by a graphics engine and processed by a display drive, into a playable multimedia stream.

4. The multimedia stream transmission method based on terahertz wireless communication according to claim 1, further comprising a handshake stage comprising the following steps:
searching, by the media receiving device, an available media providing device using a terahertz wireless signal;
receiving, by the media receiving device, an available answering instruction sent out by the media providing device;
sending out, by the media receiving device, an authentication code verification instruction to the media providing device; and
receiving, by the media receiving device, an authentication code answering instruction sent out by the media providing device and verifying the authentication code.

5. The multimedia stream transmission method based on terahertz wireless communication according to claim 1, wherein the media receiving device is a terminal device having a screen display device.

6. A multimedia stream transmission method based on terahertz wireless communication, comprising the following steps:
processing, by a media providing device, a multimedia stream into a data packet suitable for terahertz wireless signal transmission, and externally broadcasting the data packet using a terahertz wireless signal; and
receiving, by a media receiving device, the data packet using a terahertz wireless signal and processing the data packet into a playable multimedia stream.

7. The multimedia stream transmission method based on terahertz wireless communication according to claim 6, further comprising:
decoding, by the media providing device, the multimedia stream through a first multimedia codec library and packing the multimedia stream into a data packet suitable for terahertz wireless signal transmission using a first terahertz communication protocol after recoding; and
sending, by the media providing device, the data packet from a first terahertz communication interface drive to a first terahertz transceiver, wherein the first terahertz transceiver externally broadcasts the data packet using a terahertz wireless signal.

8. The multimedia stream transmission method based on terahertz wireless communication according to claim 6, further comprising:
receiving, by the media receiving device, the terahertz wireless signal using a second terahertz transceiver and acquiring the data packet, wherein the second terahertz transceiver sends the data packet to a second terahertz communication interface drive;
reading, by the second terahertz communication interface drive, the data packet, wherein after a read data packet is unpacked and corrected by a second terahertz communication protocol stack, the read data packet is decoded and translated into an image frame by a second multimedia codec library, and
translating the image frame after being drawn by a graphics engine and processed by a display drive, into a playable multimedia stream.

9. The multimedia stream transmission method based on terahertz wireless communication according to claim 6, further comprising a handshake stage comprising:
searching, by the media receiving device, an available media providing device using a terahertz wireless signal;
receiving, by the media receiving device, an available answering instruction sent out by the media providing device;
sending out, by the media receiving device, an authentication code verification instruction to the media providing device; and
receiving, by the media receiving device, an authentication code answering instruction sent out by the media providing device and verifying the authentication code.

10. The multimedia stream transmission method based on terahertz wireless communication according to claim 6, wherein the media receiving device is a terminal device having a screen display device.

11. A multimedia stream transmission system based on terahertz wireless communication, comprising:
a media providing device, for processing a multimedia stream into a data packet suitable for terahertz wireless signal transmission and externally broadcasting the data packet using a terahertz wireless signal; and
a media receiving device, for receiving the data packet using a terahertz wireless signal and processing the data packet into a playable multimedia stream.

12. The multimedia stream transmission system based on terahertz wireless communication according to claim 11, wherein the media providing device comprises three function units: a first function unit, a second function unit and a third function unit, wherein:
the first function unit is a first application operating interface for user interactive operation;
the second function unit comprises a first terahertz communication interface drive, a first terahertz communication protocol stack and a first multimedia codec library; the first terahertz communication interface drive is for reading the data packet, the first terahertz communication protocol stack is for packing the multimedia stream into the data packet, and the first multimedia codec library is for decoding and recoding the multimedia stream; and
the third function unit comprises a first terahertz transceiver for receiving the data packet suitable for terahertz wireless signal transmission.

13. The multimedia stream transmission system based on terahertz wireless communication according to claim 11, wherein the media receiving device comprises three function units: a fourth function unit, a fifth function unit and a sixth function unit, wherein:
the fourth function unit is a second application operating interface for user interactive operation;
the fifth function unit comprises a second terahertz communication interface drive, a second terahertz communication protocol stack, a second multimedia codec library, a graphics engine and a display drive; the second terahertz communication interface drive is for reading the data packet, the second terahertz communication protocol stack is for unpacking and correcting the data packet, the second multimedia codec library is for decoding and translating the data packet into an image frame, and the graphics engine and the display drive are respectively for drawing the image frame and processing the image frame into a playable multimedia stream; and
the sixth function unit comprises a second terahertz transceiver and a display device; the second terahertz transceiver is for receiving and sending the data packet suitable for terahertz wireless signal transmission and the display device is for playing and displaying the multimedia stream.

14. The multimedia stream transmission system based on terahertz wireless communication according to claim 11, wherein the media providing device is a smartphone.

15. The multimedia stream transmission system based on terahertz wireless communication according to claim 11, wherein the media providing device is a laptop computer.

16. The multimedia stream transmission system based on terahertz wireless communication according to claim 11, wherein the media providing device is a personal digital assistant.

17. The multimedia stream transmission system based on terahertz wireless communication according to claim 11, wherein the media receiving device is a projector.

18. The multimedia stream transmission system based on terahertz wireless communication according to claim 11, wherein the media receiving device is a display device.

19. The multimedia stream transmission system based on terahertz wireless communication according to claim 11, wherein the media receiving device is a television.

20. The multimedia stream transmission system based on terahertz wireless communication according to claim 11, wherein a number of media providing devices is one, while a number of media receiving devices is at least one.
